(19) United States
(12) Patent Application Publication
(10) Pub. No.: US 2026/0046815 A1
(43) Pub. Date: Feb. 12, 2026

(54) Group-Based Positioning Procedures for Reduced Capacity Devices

(71) Applicant: Apple Inc., Cupertino, CA (US)

(72) Inventors: Oghenekome Oteri, San Diego, CA (US); Alexander Sirotkin, Hod Hasharon (IL); Chunxuan Ye, San Diego, CA (US); Dawei Zhang, Saratoga, CA (US); Huaning Niu, San Jose, CA (US); Wei Zeng, Saratoga, CA (US); Sigen Ye, San Diego, CA (US); Ankit Bhamri, Haar (DE); Hong He, San Jose, CA (US); Chunhai Yao, Beijing (CN)

(21) Appl. No.: 19/101,121

(22) PCT Filed: Aug. 10, 2022
(86) PCT No.: PCT/CN2022/111371

§ 371 Date: Feb. 4, 2025

(51) Int. Cl. H04W 64/00

(52) U.S. Cl. CPC H04W 64/00

(57) ABSTRACT

Apparatuses, systems, and methods for positioning procedures for reduced capacity devices, e.g., in 5G NR systems and beyond. A UE may determine a group of UEs to participate in group-based positioning, e.g., via communication with an LMF of a network and/or via peer-to-peer communications with neighboring UEs. The UE may participate in selection of a delegate UE from the group of UEs where the delegate UE may perform a positioning procedure with a network entity of the network. The selection may be network based (e.g., the delegate UE is selected by the LMF) or local (e.g., the group of UEs select/elect the delegate UE). Additionally, the UE may receive a position estimate based on the positioning procedure performed by the delegate UE and the network entity. The position estimate may be received via a broadcast or unicast message from the LMF and/or from the delegate UE.

### FIELD

The invention relates to wireless communications, and more particularly to apparatuses, systems, and methods for positioning procedures for reduced capacity devices, e.g., in cellular systems, such as LTE systems, 5G NR systems, and beyond.

### DESCRIPTION OF THE RELATED ART

Wireless communication systems are rapidly growing in usage. In recent years, wireless devices such as smart phones, wearable devices or accessory devices), and tablet computers have become increasingly sophisticated. In addition to supporting telephone calls, many mobile devices now provide access to the internet, email, text messaging, and navigation using the global positioning system (GPS), and are capable of operating sophisticated applications that utilize these functionalities.

Long Term Evolution (LTE) is currently the technology of choice for the majority of wireless network operators worldwide, providing mobile broadband data and high-speed Internet access to their subscriber base. LTE was first proposed in 2004 and was first standardized in 2008. Since then, as usage of wireless communication systems has expanded exponentially, demand has risen for wireless network operators to support a higher capacity for a higher density of mobile broadband users. Thus, in 2015 study of a new radio access technology began and, in 2017, a first release of Fifth Generation New Radio (5G NR) was standardized.

5G-NR, also simply referred to as NR, provides, as compared to LTE, a higher capacity for a higher density of mobile broadband users, while also supporting device-to-device, ultra-reliable, and massive machine type communications with lower latency and/or lower battery consumption. Further, NR may allow for more flexible UE scheduling as compared to current LTE. Consequently, efforts are being made in ongoing developments of 5G-NR to take advantage of higher throughputs possible at higher frequencies.

### SUMMARY

Embodiments relate to wireless communications, and more particularly to apparatuses, systems, and methods for positioning procedures for reduced capacity devices, e.g., in 5G NR systems and beyond.

For example, in some embodiments, a UE may be configured to determine a group of UEs to participate in group-based positioning, e.g., via communication with a location management function of a network and/or via peer-to-peer communications with neighboring UEs. The UE may be configured to participate in selection of a delegate UE from the group of UEs where the delegate UE may perform a positioning procedure with a network entity of the network. The selection may be network based (e.g., the delegate UE is selected by the LMF) or local (e.g., the group of UEs select/elect the delegate UE). Additionally, the UE may be configured to receive a position estimate based on the positioning procedure performed by the delegate UE and the network entity. The position estimate may be received via a broadcast or unicast message from the LMF and/or from the delegate UE.

As another example, in some embodiments, a UE may be configured to enter, after expiration of an inactivity timer, a DRX cycle, e.g., while operating in a radio resource control (RRC) connected mode. The UE may be configured to switch to a first PRS configuration that may correspond to a first periodic wakeup cycle of the DRX cycle. The UE may be configured to enter, upon expiration of a timer associated with a first portion of the DRX cycle, a second portion of the DRX cycle. The first portion of the DRX cycle may correspond to the first periodic wakeup cycle and the second portion of the DRX cycle may correspond to the second periodic wakeup cycle. Additionally, the UE may be configured to switch from the first PRS configuration to a second PRS configuration, e.g., based, at least in part, on the expiration of the timer and/or based, at least in part, on entering the second portion of the DRX cycle. The second PRS configuration may correspond to a second periodic wakeup cycle of the DRX cycle.

As a further example, in some embodiments, a UE may be configured to receive, from a location management function (LMF), a positioning configuration. The UE may be in a radio resource control (RRC) idle mode and/or in an RRC inactive mode and the positioning configuration may be an RRC idle mode positioning configuration. The positioning configuration may specify a schedule and/or periodicity for a paging occasion and one or more additional paging occasions. The UE may be configured to attend a paging occasion, e.g., based on the positioning configuration, and receive, from a base station, one or more PRSs according to the positioning configuration. e.g., in the paging occasion.

The techniques described herein may be implemented in and/or used with a number of different types of devices, including but not limited to unmanned aerial vehicles (UAVs), unmanned aerial controllers (UACs), a UTM server, base stations, access points, cellular phones, tablet computers, wearable computing devices, portable media players, and any of various other computing devices.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the present subject matter can be obtained when the following detailed description of various embodiments is considered in conjunction with the following drawings, in which:

FIG. 1A illustrates an example wireless communication system according to some embodiments.

FIG. 1B illustrates an example of a base station and an access point in communication with a user equipment (UE) device, according to some embodiments.

FIG. 2 illustrates an example block diagram of a base station, according to some embodiments.

FIG. 3 illustrates an example block diagram of a server according to some embodiments.

FIG. 4 illustrates an example block diagram of a UE according to some embodiments.

FIG. 5 illustrates an example block diagram of cellular communication circuitry, according to some embodiments.

FIG. 6A illustrates an example of a 5G network architecture that incorporates both 3GPP (e.g., cellular) and non-3GPP (e.g., non-cellular) access to the 5G CN, according to some embodiments.

FIG. 6B illustrates an example of a 5G network architecture that incorporates both dual 3GPP (e.g., LTE and 5G NR) access and non-3GPP access to the 5G CN, according to some embodiments.

FIG. 7 illustrates an example of a baseband processor architecture for a UE, according to some embodiments.

FIGS. 8A and 8B illustrate capability differences between reduced capacity devices and enhanced mobile broadband devices.

FIG. 8C illustrates usage scenarios and associated requirements for reduced capacity devices.

FIG. 9A illustrates an example of group-based positioning for co-located UEs, according to some embodiments.

FIG. 9B illustrates an example of group-based positioning for a group of UEs within a bounded area, according to some embodiments.

FIG. 9C illustrates an example of group-based positioning using a delegate UE and a local positioning procedure, according to some embodiments.

FIG. 10 illustrates a block diagram of an example of a method for group-based positioning, according to some embodiments.

FIG. 11 illustrates an example of multiple PRS configurations associated with a UE's varying discontinuous reception cycle (DRX), according to some embodiments.

FIG. 12 illustrates a block diagram of an example of a method for reception of PRSs during a DRX, according to some embodiments.

For example, FIG. 13 illustrates an example of signaling for reception of PRSs, according to some embodiments.

FIG. 14 illustrates a block diagram of an example of a method for reception of a PRS during a paging occasion, according to some embodiments.

While the features described herein may be susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Acronyms

Various acronyms are used throughout the present disclosure. Definitions of the most prominently used acronyms that may appear throughout the present disclosure are provided below:
3GPP: Third Generation Partnership Project
UE: User Equipment
RF: Radio Frequency
DL: Downlink
UL: Uplink
LTE: Long Term Evolution
NR: New Radio
5GS: 5G System
5GMM: 5GS Mobility Management
5GC/5GCN: 5G Core Network
IE: Information Element
CE: Control Element
MAC: Medium Access Control
SSB: Synchronization Signal Block
CSI: Channel State Information
CSI-RS: Channel State Information Reference Signal
CMR: Channel Measurement Resource
PDCCH: Physical Downlink Control Channel.
PDSCH: Physical Downlink Shared Channel.
RRC: Radio Resource Control
RRM: Radio Resource Management
CORESET: Control Resource Set
TCI: Transmission Configuration Indicator
DCI: Downlink Control Indicator.
NPN: Non-Public Network
SNPN: Standalone NPN
CAG: Closed Access Group
SON: Self-Organizing Network
MDT: Minimization of Drive Test

### Terms

The following is a glossary of terms used in this disclosure:

Memory Medium—Any of various types of non-transitory memory devices or storage devices. The term “memory medium” is intended to include an installation medium, e.g., a CD-ROM, floppy disks, or tape device; a computer system memory or random-access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may include other types of non-transitory memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer for execution. The term “memory medium” may include two or more memory mediums which may reside in different locations, e.g., in different computer systems that are connected over a network. The memory medium may store program instructions (e.g., embodied as computer programs) that may be executed by one or more processors.

Carrier Medium—a memory medium as described above, as well as a physical transmission medium, such as a bus, network, and/or other physical transmission medium that conveys signals such as electrical, electromagnetic, or digital signals.

Programmable Hardware Element—includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic”.

Computer System (or Computer)—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.

User Equipment (UE) (or “UE Device”)—any of various types of computer systems devices which are mobile or portable and which performs wireless communications. Examples of UE devices include mobile telephones or smart phones (e.g., iPhone™, Android™-based phones), portable gaming devices (e.g., Nintendo DS™, PlayStation Portable™, Gameboy Advance™, iPhone™), laptops, wearable devices (e.g., smart watch, smart glasses), PDAS, portable Internet devices, music players, data storage devices, other handheld devices, unmanned aerial vehicles (UAVs) (e.g., drones), UAV controllers (UACs), and so forth. In general, the term “UE” or “UE device” can be broadly defined to encompass any electronic, computing, and/or telecommunications device (or combination of devices) which is easily transported by a user and capable of wireless communication.

Base Station—The term “Base Station” has the full breadth of its ordinary meaning, and at least includes a wireless communication station installed at a fixed location and used to communicate as part of a wireless telephone system or radio system.

Processing Element (or Processor)—refers to various elements or combinations of elements that are capable of performing a function in a device, such as a user equipment or a cellular network device. Processing elements may include, for example: processors and associated memory, portions or circuits of individual processor cores, entire processor cores, processor arrays, circuits such as an ASIC (Application Specific Integrated Circuit), programmable hardware elements such as a field programmable gate array (FPGA), as well any of various combinations of the above.

Channel—a medium used to convey information from a sender (transmitter) to a receiver. It should be noted that since characteristics of the term “channel” may differ according to different wireless protocols, the term “channel” as used herein may be considered as being used in a manner that is consistent with the standard of the type of device with reference to which the term is used. In some standards, channel widths may be variable (e.g., depending on device capability, band conditions, etc.). For example, LTE may support scalable channel bandwidths from 1.4 MHz to 20 MHz. In contrast, WLAN channels may be 22 MHz wide while Bluetooth channels may be 1 Mhz wide. Other protocols and standards may include different definitions of channels. Furthermore, some standards may define and use multiple types of channels, e.g., different channels for uplink or downlink and/or different channels for different uses such as data, control information, etc.

Band—The term “band” has the full breadth of its ordinary meaning, and at least includes a section of spectrum (e.g., radio frequency spectrum) in which channels are used or set aside for the same purpose.

Wi-Fi—The term “Wi-Fi” (or WiFi) has the full breadth of its ordinary meaning, and at least includes a wireless communication network or RAT that is serviced by wireless LAN (WLAN) access points and which provides connectivity through these access points to the Internet. Most modern Wi-Fi networks (or WLAN networks) are based on IEEE 802.11 standards and are marketed under the name “Wi-Fi”. A Wi-Fi (WLAN) network is different from a cellular network.

3GPP Access—refers to accesses (e.g., radio access technologies) that are specified by 3GPP standards. These accesses include, but are not limited to, GSM/GPRS, LTE, LTE-A, and/or 5G NR. In general, 3GPP access refers to various types of cellular access technologies.

Non-3GPP Access—refers any accesses (e.g., radio access technologies) that are not specified by 3GPP standards. These accesses include, but are not limited to, WiMAX, CDMA2000, Wi-Fi, WLAN, and/or fixed networks. Non-3GPP accesses may be split into two categories, “trusted” and “untrusted”: Trusted non-3GPP accesses can interact directly with an evolved packet core (EPC) and/or a 5G core (5GC) whereas untrusted non-3GPP accesses interwork with the EPC/5GC via a network entity, such as an Evolved Packet Data Gateway and/or a 5G NR gateway. In general, non-3GPP access refers to various types on non-cellular access technologies.

Automatically—refers to an action or operation performed by a computer system (e.g., software executed by the computer system) or device (e.g., circuitry, programmable hardware elements, ASICs, etc.), without user input directly specifying or performing the action or operation. Thus, the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions the user has taken.

Approximately—refers to a value that is almost correct or exact. For example, approximately may refer to a value that is within 1 to 10 percent of the exact (or desired) value. It should be noted, however, that the actual threshold value (or tolerance) may be application dependent. For example, in some embodiments, “approximately” may mean within 0.1% of some specified or desired value, while in various other embodiments, the threshold may be, for example, 2%, 3%, 5%, and so forth, as desired or as required by the particular application.

Concurrent—refers to parallel execution or performance, where tasks, processes, or programs are performed in an at least partially overlapping manner. For example, concurrency may be implemented using “strong” or strict parallelism, where tasks are performed (at least partially) in parallel on respective computational elements, or using “weak parallelism”, where the tasks are performed in an interleaved manner, e.g., by time multiplexing of execution threads.

Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to” may include hardware circuits.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112 (f) interpretation for that component.

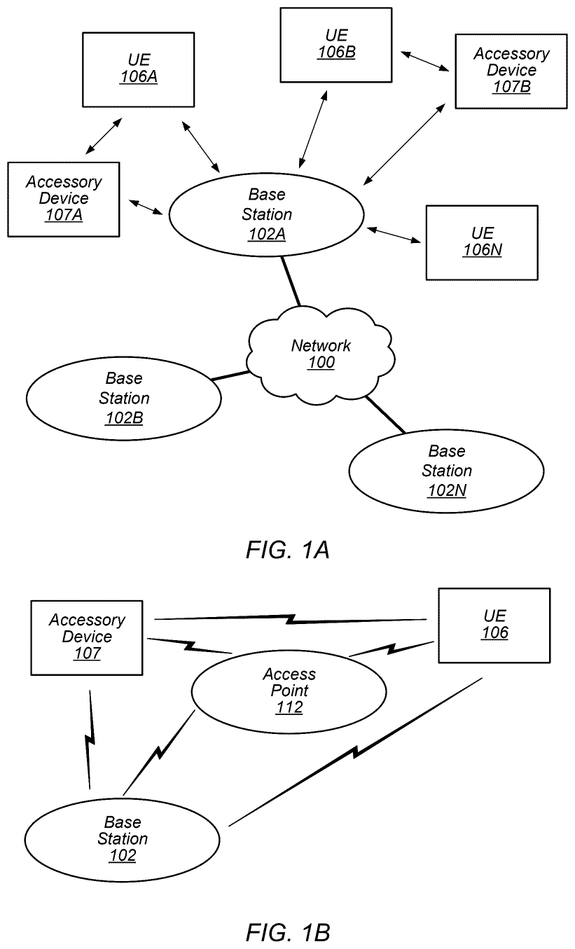

### FIGS. 1A and 1B: Communication Systems

FIG. 1A illustrates a simplified example wireless communication system, according to some embodiments. It is noted that the system of FIG. 1A is merely one example of a possible system, and that features of this disclosure may be implemented in any of various systems, as desired.

As shown, the example wireless communication system includes a base station 102A which communicates over a transmission medium with one or more wireless devices, such as user devices 106A, 106B, etc., through 106N, as well as accessory devices, such as user devices 107A, 107B. Each of the user devices may be referred to herein as a “user equipment” (UE). Thus, the user devices 106 and 107 are referred to as UEs or UE devices.

The base station (BS) 102A may be a base transceiver station (BTS) or cell site (a “cellular base station”) and may include hardware that enables wireless communication with the UEs 106A through 106N as well as UEs 107A and 107B.

The communication area (or coverage area) of the base station may be referred to as a “cell.” The base station 102A and the UEs 106/107 may be configured to communicate over the transmission medium using any of various radio access technologies (RATs), also referred to as wireless communication technologies, or telecommunication standards, such as GSM, UMTS (associated with, for example, WCDMA or TD-SCDMA air interfaces), LTE, LTE-Advanced (LTE-A), 5G new radio (5G NR), HSPA, 3GPP2 CDMA2000 (e.g., 1×RTT, 1×EV-DO, HRPD, cHRPD), etc. Note that if the base station 102A is implemented in the context of LTE, it may alternately be referred to as an ‘eNodeB’ or ‘eNB’. Note that if the base station 102A is implemented in the context of 5G NR, it may alternately be referred to as ‘gNodeB’ or ‘gNB’.

As shown, the base station 102A may also be equipped to communicate with a network 100 (e.g., a core network of a cellular service provider, a telecommunication network such as a public switched telephone network (PSTN), and/or the Internet, among various possibilities). Thus, the base station 102A may facilitate communication between the user devices and/or between the user devices and the network 100. In particular, the cellular base station 102A may provide UEs 106/107 with various telecommunication capabilities, such as voice, SMS and/or data services.

Base station 102A and other similar base stations (such as base stations 102B . . . 102N) operating according to the same or a different cellular communication standard may thus be provided as a network of cells, which may provide continuous or nearly continuous overlapping service to UEs 106A-N and similar devices over a geographic area via one or more cellular communication standards.

Thus, while base station 102A may act as a “serving cell” for UEs 106/107 as illustrated in FIG. 1, each UE 106/107 may also be capable of receiving signals from (and possibly within communication range of) one or more other cells (which might be provided by base stations 102B-N and/or any other base stations), which may be referred to as “neighboring cells”. Such cells may also be capable of facilitating communication between user devices and/or between user devices and the network 100. Such cells may include “macro” cells, “micro” cells, “pico” cells, and/or cells which provide any of various other granularities of service area size. For example, base stations 102A-B illustrated in FIG. 1 might be macro cells, while base station 102N might be a micro cell. Other configurations are also possible.

In some embodiments, base station 102A may be a next generation base station, e.g., a 5G New Radio (5G NR) base station, or “gNB”. In some embodiments, a gNB may be connected to a legacy evolved packet core (EPC) network and/or to a NR core (NRC) network. In addition, a gNB cell may include one or more transition and reception points (TRPs). In addition, a UE capable of operating according to 5G NR may be connected to one or more TRPs within one or more gNBs.

Note that a UE 106/107 may be capable of communicating using multiple wireless communication standards. For example, the UE 106/107 may be configured to communicate using a wireless networking (e.g., Wi-Fi) and/or peer-to-peer wireless communication protocol (e.g., Bluetooth, Wi-Fi peer-to-peer, etc.) in addition to at least one cellular communication protocol (e.g., GSM, UMTS (associated with, for example, WCDMA or TD-SCDMA air interfaces), LTE, LTE-A, 5G NR, HSPA, 3GPP2 CDMA2000 (e.g., 1×RTT, 1×EV-DO, HRPD, cHRPD), etc.). The UE 106/107 may also or alternatively be configured to communicate using one or more global navigational satellite systems (GNSS, e.g., GPS or GLONASS), one or more mobile television broadcasting standards (e.g., ATSC-M/H or DVB-H), and/or any other wireless communication protocol, if desired. Other combinations of wireless communication standards (including more than two wireless communication standards) are also possible.

Note that accessory devices 107A/B may include cellular communication capability and hence are able to directly communicate with cellular base station 102A via a cellular RAT. However, since the accessory devices 107A/B are possibly one or more of communication, output power, and/or battery limited, the accessory devices 107A/B may in some instances selectively utilize the UEs 106A/B as a proxy for communication purposes with the base station 102A and hence to the network 100. In other words, the accessory devices 107A/B may selectively use the cellular communication capabilities of its companion device (e.g., UEs 106A/B) to conduct cellular communications. The limitation on communication abilities of the accessory devices 107A/B may be permanent, e.g., due to limitations in output power or the RATs supported, or temporary, e.g., due to conditions such as current battery status, inability to access a network, or poor reception.

FIG. 1B illustrates user equipment 106 (e.g., one of the devices 106A through 106N) and accessory device (or user equipment) 107 (e.g., one of the devices 107A or 107B) in communication with a base station 102 and an access point 112 as well as one another, according to some embodiments. The UEs 106/107 may be devices with both cellular communication capability and non-cellular communication capability (e.g., Bluetooth, Wi-Fi, and so forth) such as a mobile phone, a wearable device, a hand-held device, a computer or a tablet, or virtually any type of wireless device. The accessory device 107 may be a wearable device such as a smart watch. The accessory device 107 may comprise cellular communication capability and be capable of directly communicating with the base station 102 as shown. Note that when the accessory device 107 is configured to directly communicate with the base station, the accessory device may be said to be in “autonomous mode.” In addition, the accessory device 107 may also be capable of communicating with another device (e.g., UE 106), referred to as a proxy device, intermediate device, or companion device, using a short-range communications protocol; for example, the accessory device 107 may according to some embodiments be “paired” with the UE 106, which may include establishing a communication channel and/or a trusted communication relationship with the UE 106. Under some circumstances, the accessory device 107 may use the cellular functionality of this proxy device for communicating cellular voice and/or data with the base station 102. In other words, the accessory device 107 may provide voice and/or data packets intended for the base station 102 over the short-range link to the UE 106, and the UE 106 may use its cellular functionality to transmit (or relay) this voice and/or data to the base station on behalf of the accessory device 107. Similarly, the voice and/or data packets transmitted by the base station and intended for the accessory device 107 may be received by the cellular functionality of the UE 106 and then may be relayed over the short-range link to the accessory device. As noted above, the UE 106 may be a mobile phone, a tablet, or any other type of hand-held device, a media player, a computer, a laptop or virtually any type of wireless device. Note that when the accessory device 107 is configured to indirectly communicate with the base station 102 using the cellular functionality of an intermediate or proxy device, the accessory device may be said to be in “relay mode.”

The UE 106/107 may include a processor that is configured to execute program instructions stored in memory. The UE 106/107 may perform any of the method embodiments described herein by executing such stored instructions. Alternatively, or in addition, the UE 106/107 may include a programmable hardware element such as an FPGA (field-programmable gate array) that is configured to perform any of the method embodiments described herein, or any portion of any of the method embodiments described herein.

The UE 106/107 may include one or more antennas for communicating using one or more wireless communication protocols or technologies. In some embodiments, the UE 106 may be configured to communicate using, for example, CDMA2000 (1×RTT/1×EV-DO/HRPD/cHRPD), LTE/LTE-Advanced, or 5G NR using a single shared radio and/or GSM, LTE, LTE-Advanced, or 5G NR using the single shared radio. The shared radio may couple to a single antenna, or may couple to multiple antennas (e.g., for MIMO) for performing wireless communications. In general, a radio may include any combination of a baseband processor, analog RF signal processing circuitry (e.g., including filters, mixers, oscillators, amplifiers, etc.), or digital processing circuitry (e.g., for digital modulation as well as other digital processing). Similarly, the radio may implement one or more receive and transmit chains using the aforementioned hardware. For example, the UE 106/107 may share one or more parts of a receive and/or transmit chain between multiple wireless communication technologies, such as those discussed above.

In some embodiments, the UE 106/107 may include separate transmit and/or receive chains (e.g., including separate antennas and other radio components) for each wireless communication protocol with which it is configured to communicate. As a further possibility, the UE 106/107 may include one or more radios which are shared between multiple wireless communication protocols, and one or more radios which are used exclusively by a single wireless communication protocol. For example, the UE 106/107 might include a shared radio for communicating using either of LTE or 5G NR (or LTE or 1×RTT or LTE or GSM), and separate radios for communicating using each of Wi-Fi and Bluetooth. Other configurations are also possible.

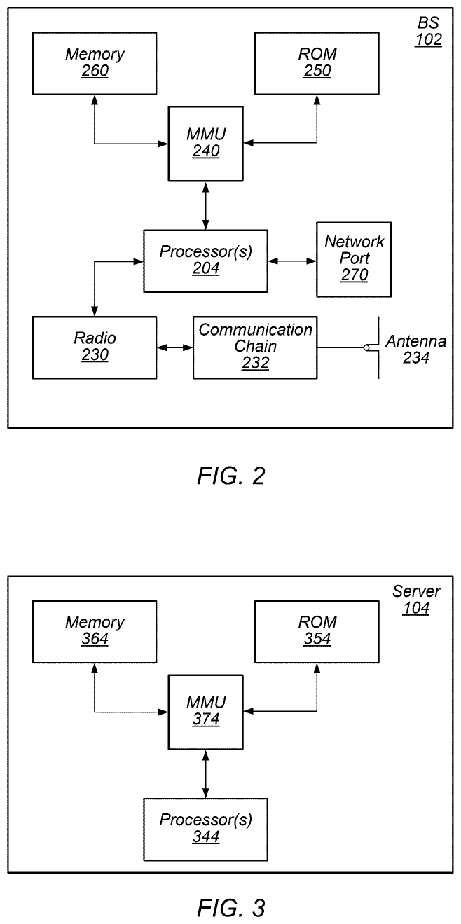

### FIG. 2: Block Diagram of a Base Station

FIG. 2 illustrates an example block diagram of a base station 102, according to some embodiments. It is noted that the base station of FIG. 3 is merely one example of a possible base station. As shown, the base station 102 may include processor(s) 204 which may execute program instructions for the base station 102. The processor(s) 204 may also be coupled to memory management unit (MMU) 240, which may be configured to receive addresses from the processor(s) 204 and translate those addresses to locations in memory (e.g., memory 260 and read only memory (ROM) 250) or to other circuits or devices.

The base station 102 may include at least one network port 270. The network port 270 may be configured to couple to a telephone network and provide a plurality of devices, such as UE devices 106, access to the telephone network as described above in FIGS. 1 and 2.

The network port 270 (or an additional network port) may also or alternatively be configured to couple to a cellular network, e.g., a core network of a cellular service provider. The core network may provide mobility related services and/or other services to a plurality of devices, such as UE devices 106. In some cases, the network port 270 may couple to a telephone network via the core network, and/or the core network may provide a telephone network (e.g., among other UE devices serviced by the cellular service provider).

In some embodiments, base station 102 may be a next generation base station, e.g., a 5G New Radio (5G NR) base station, or “gNB”. In such embodiments, base station 102 may be connected to a legacy evolved packet core (EPC) network and/or to a NR core (NRC) network. In addition, base station 102 may be considered a 5G NR cell and may include one or more transition and reception points (TRPs). In addition, a UE capable of operating according to 5G NR may be connected to one or more TRPs within one or more gNBs.

The base station 102 may include at least one antenna 234, and possibly multiple antennas. The at least one antenna 234 may be configured to operate as a wireless transceiver and may be further configured to communicate with UE devices 106 via radio 230. The antenna 234 communicates with the radio 230 via communication chain 232. Communication chain 232 may be a receive chain, a transmit chain or both. The radio 230 may be configured to communicate via various wireless communication standards, including, but not limited to, 5G NR, LTE, LTE-A, GSM, UMTS, CDMA2000, Wi-Fi, etc.

The base station 102 may be configured to communicate wirelessly using multiple wireless communication standards. In some instances, the base station 102 may include multiple radios, which may enable the base station 102 to communicate according to multiple wireless communication technologies. For example, as one possibility, the base station 102 may include an LTE radio for performing communication according to LTE as well as a 5G NR radio for performing communication according to 5G NR. In such a case, the base station 102 may be capable of operating as both an LTE base station and a 5G NR base station. As another possibility, the base station 102 may include a multi-mode radio which is capable of performing communications according to any of multiple wireless communication technologies (e.g., 5G NR and Wi-Fi, LTE and Wi-Fi, LTE and UMTS, LTE and CDMA2000, UMTS and GSM, etc.).

As described further subsequently herein, the BS 102 may include hardware and software components for implementing or supporting implementation of features described herein. The processor 204 of the base station 102 may be configured to implement or support implementation of part or all of the methods described herein, e.g., by executing program instructions stored on a memory medium (e.g., a non-transitory computer-readable memory medium). Alternatively, the processor 204 may be configured as a programmable hardware element, such as an FPGA (Field Programmable Gate Array), or as an ASIC (Application Specific Integrated Circuit), or a combination thereof. Alternatively (or in addition) the processor 204 of the BS 102, in conjunction with one or more of the other components 230, 232, 234, 240, 250, 260, 270 may be configured to implement or support implementation of part or all of the features described herein.

In addition, as described herein, processor(s) 204 may be comprised of one or more processing elements. In other words, one or more processing elements may be included in processor(s) 204. Thus, processor(s) 204 may include one or more integrated circuits (Ics) that are configured to perform the functions of processor(s) 204. In addition, each integrated circuit may include circuitry (e.g., first circuitry, second circuitry, etc.) configured to perform the functions of processor(s) 204.

Further, as described herein, radio 230 may be comprised of one or more processing elements. In other words, one or more processing elements may be included in radio 230. Thus, radio 230 may include one or more integrated circuits (Ics) that are configured to perform the functions of radio 230. In addition, each integrated circuit may include circuitry (e.g., first circuitry, second circuitry, etc.) configured to perform the functions of radio 230.

### FIG. 3: Block Diagram of a Server

FIG. 3 illustrates an example block diagram of a server 104, according to some embodiments. It is noted that the server of FIG. 3 is merely one example of a possible server. As shown, the server 104 may include processor(s) 344 which may execute program instructions for the server 104. The processor(s) 344 may also be coupled to memory management unit (MMU) 374, which may be configured to receive addresses from the processor(s) 344 and translate those addresses to locations in memory (e.g., memory 364 and read only memory (ROM) 354) or to other circuits or devices.

The server 104 may be configured to provide a plurality of devices, such as base station 102, UE devices 106, and/or UTM 108, access to network functions, e.g., as further described herein.

In some embodiments, the server 104 may be part of a radio access network, such as a 5G New Radio (5G NR) radio access network. In some embodiments, the server 104 may be connected to a legacy evolved packet core (EPC) network and/or to a NR core (NRC) network.

As described further subsequently herein, the server 104 may include hardware and software components for implementing or supporting implementation of features described herein. The processor 344 of the server 104 may be configured to implement or support implementation of part or all of the methods described herein, e.g., by executing program instructions stored on a memory medium (e.g., a non-transitory computer-readable memory medium). Alternatively, the processor 344 may be configured as a programmable hardware element, such as an FPGA (Field Programmable Gate Array), or as an ASIC (Application Specific Integrated Circuit), or a combination thereof. Alternatively (or in addition) the processor 344 of the server 104, in conjunction with one or more of the other components 354, 364, and/or 374 may be configured to implement or support implementation of part or all of the features described herein.

In addition, as described herein, processor(s) 344 may be comprised of one or more processing elements. In other words, one or more processing elements may be included in processor(s) 344. Thus, processor(s) 344 may include one or more integrated circuits (Ics) that are configured to perform the functions of processor(s) 344. In addition, each integrated circuit may include circuitry (e.g., first circuitry, second circuitry, etc.) configured to perform the functions of processor(s) 344.

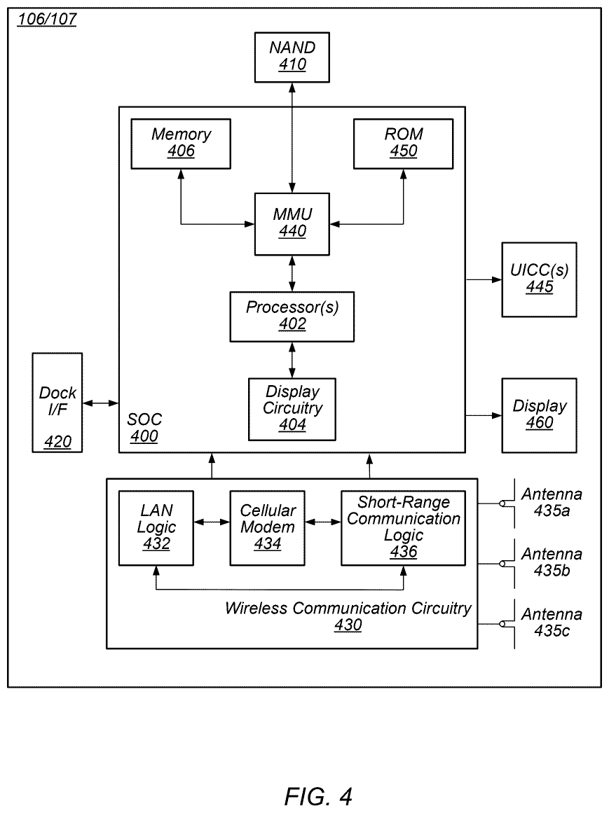

### FIG. 4: Block Diagram of a UE

FIG. 4 illustrates an example simplified block diagram of a communication device 106/107, according to some embodiments. It is noted that the block diagram of the communication device of FIG. 4 is only one example of a possible communication device. According to embodiments, communication device 106/107 may be a user equipment (UE) device, a mobile device or mobile station, a wireless device or wireless station, a desktop computer or computing device, a mobile computing device (e.g., a laptop, notebook, or portable computing device), a wearable device, a tablet, an unmanned aerial vehicle (UAV), a UAV controller (UAC) and/or a combination of devices, among other devices. As shown, the communication device 106/107 may include a set of components 400 configured to perform core functions. For example, this set of components may be implemented as a system on chip (SOC), which may include portions for various purposes. Alternatively, this set of components 400 may be implemented as separate components or groups of components for the various purposes. The set of components 400 may be coupled (e.g., communicatively; directly or indirectly) to various other circuits of the communication device 106.

For example, the communication device 106/107 may include various types of memory (e.g., including NAND flash 410), an input/output interface such as connector I/F 420 (e.g., for connecting to a computer system; dock; charging station; input devices, such as a microphone, camera, keyboard; output devices, such as speakers; etc.), the display 460, which may be integrated with or external to the communication device 106/107, and wireless communication circuitry 430. The wireless communication circuitry 430 may include a cellular modem 434 such as for 5G NR, LTE, GSM, etc., and short to medium range wireless communication logic 436 (e.g., Bluetooth™ and WLAN circuitry). In some embodiments, communication device 106/107 may include wired communication circuitry (not shown), such as a network interface card, e.g., for Ethernet.

The wireless communication circuitry 430 may couple (e.g., communicatively; directly or indirectly) to one or more antennas, such as antennas 435a, 435b, and 435c (e.g., 435a-c) as shown. The wireless communication circuitry 430 may include local area network (LAN) logic 432, the cellular modem 434, and/or short-range communication logic 436. The LAN logic 432 may be for enabling the UE device 106/107 to perform LAN communications, such as Wi-Fi communications on an 802.11 network, and/or other WLAN communications. The short-range communication logic 436 may be for enabling the UE device 106/107 to perform communications according to a short-range RAT, such as Bluetooth or UWB communications. In some scenarios, the cellular modem 434 may be a lower power cellular modem capable of performing cellular communication according to one or more cellular communication technologies.

In some embodiments, as further described below, cellular modem 434 may include dedicated receive chains (including and/or coupled to, e.g., communicatively; directly or indirectly. dedicated processors and/or radios) for multiple RATs (e.g., a first receive chain for LTE and a second receive chain for 5G NR). In addition, in some embodiments, cellular modem 434 may include a single transmit chain that may be switched between radios dedicated to specific RATs. For example, a first radio may be dedicated to a first RAT, e.g., LTE, and may be in communication with a dedicated receive chain and a transmit chain shared with an additional radio, e.g., a second radio that may be dedicated to a second RAT, e.g., 5G NR, and may be in communication with a dedicated receive chain and the shared transmit chain.

The communication device 106/107 may also include and/or be configured for use with one or more user interface elements. The user interface elements may include any of various elements, such as display 460 (which may be a touchscreen display), a keyboard (which may be a discrete keyboard or may be implemented as part of a touchscreen display), a mouse, a microphone and/or speakers, one or more cameras, one or more buttons, and/or any of various other elements capable of providing information to a user and/or receiving or interpreting user input.

The communication device 106/107 may further include one or more smart cards 445 that include SIM (Subscriber Identity Module) functionality, such as one or more UICC(s) (Universal Integrated Circuit Card(s)) cards 445. Note that the term “SIM” or “SIM entity” is intended to include any of various types of SIM implementations or SIM functionality, such as the one or more UICC(s) cards 445, one or more eUICCs, one or more eSIMs, either removable or embedded, etc. In some embodiments, the UE 106/107 may include at least two SIMs. Each SIM may execute one or more SIM applications and/or otherwise implement SIM functionality. Thus, each SIM may be a single smart card that may be embedded, e.g., may be soldered onto a circuit board in the UE 106/107, or each SIM 410 may be implemented as a removable smart card. Thus, the SIM(s) may be one or more removable smart cards (such as UICC cards, which are sometimes referred to as “SIM cards”), and/or the SIMS 410 may be one or more embedded cards (such as embedded UICCs (eUICCs), which are sometimes referred to as “eSIMs” or “eSIM cards”). In some embodiments (such as when the SIM(s) include an eUICC), one or more of the SIM(s) may implement embedded SIM (eSIM) functionality; in such an embodiment, a single one of the SIM(s) may execute multiple SIM applications. Each of the SIMs may include components such as a processor and/or a memory; instructions for performing SIM/eSIM functionality may be stored in the memory and executed by the processor. In some embodiments, the UE 106/107 may include a combination of removable smart cards and fixed/non-removable smart cards (such as one or more eUICC cards that implement eSIM functionality), as desired. For example, the UE 106/107 may comprise two embedded SIMs, two removable SIMs, or a combination of one embedded SIMs and one removable SIMs. Various other SIM configurations are also contemplated.

As noted above, in some embodiments, the UE 106/107 may include two or more SIMs. The inclusion of two or more SIMs in the UE 106/107 may allow the UE 106/107 to support two different telephone numbers and may allow the UE 106/107 to communicate on corresponding two or more respective networks. For example, a first SIM may support a first RAT such as LTE, and a second SIM 410 support a second RAT such as 5G NR. Other implementations and RATs are of course possible. In some embodiments, when the UE 106/107 comprises two SIMs, the UE 106/107 may support Dual SIM Dual Active (DSDA) functionality. The DSDA functionality may allow the UE 106/107 to be simultaneously connected to two networks (and use two different RATs) at the same time, or to simultaneously maintain two connections supported by two different SIMs using the same or different RATs on the same or different networks. The DSDA functionality may also allow the UE 106/107 to simultaneously receive voice calls or data traffic on either phone number. In certain embodiments the voice call may be a packet switched communication. In other words, the voice call may be received using voice over LTE (VoLTE) technology and/or voice over NR (VONR) technology. In some embodiments, the UE 106/107 may support Dual SIM Dual Standby (DSDS) functionality. The DSDS functionality may allow either of the two SIMs in the UE 106/107 to be on standby waiting for a voice call and/or data connection. In DSDS, when a call/data is established on one SIM, the other SIM is no longer active. In some embodiments, DSDx functionality (either DSDA or DSDS functionality) may be implemented with a single SIM (e.g., a eUICC) that executes multiple SIM applications for different carriers and/or RATs.

As shown, the SOC 400 may include processor(s) 402, which may execute program instructions for the communication device 106 and display circuitry 404, which may perform graphics processing and provide display signals to the display 460. The processor(s) 402 may also be coupled to memory management unit (MMU) 440, which may be configured to receive addresses from the processor(s) 402 and translate those addresses to locations in memory (e.g., memory 406, read only memory (ROM) 450, NAND flash memory 410) and/or to other circuits or devices, such as the display circuitry 404, short to medium range wireless communication circuitry 429, cellular communication circuitry 430, connector I/F 420, and/or display 460. The MMU 440 may be configured to perform memory protection and page table translation or set up. In some embodiments, the MMU 440 may be included as a portion of the processor(s) 402.

As noted above, the communication device 106 may be configured to communicate using wireless and/or wired communication circuitry. The communication device 106 may be configured to perform methods for positioning procedures for reduced capacity devices, e.g., in 5G NR systems and beyond, as further described herein.

As described herein, the communication device 106/107 may include hardware and software components for implementing the above features for a communication device 106/107 to communicate a scheduling profile for power savings to a network. The processor 402 of the communication device 106/107 may be configured to implement part or all of the features described herein, e.g., by executing program instructions stored on a memory medium (e.g., a non-transitory computer-readable memory medium). Alternatively (or in addition), processor 402 may be configured as a programmable hardware element, such as an FPGA (Field Programmable Gate Array), or as an ASIC (Application Specific Integrated Circuit). Alternatively (or in addition) the processor 402 of the communication device 106, in conjunction with one or more of the other components 400, 404, 406, 410, 420, 429, 430, 440, 445, 450, 460 may be configured to implement part or all of the features described herein.

In addition, as described herein, processor 402 may include one or more processing elements. Thus, processor 402 may include one or more integrated circuits (Ics) that are configured to perform the functions of processor 402. In addition, each integrated circuit may include circuitry (e.g., first circuitry, second circuitry, etc.) configured to perform the functions of processor(s) 402.

Further, as described herein, cellular communication circuitry 430 and short to medium range wireless communication circuitry 429 may each include one or more processing elements. In other words, one or more processing elements may be included in cellular communication circuitry 430 and, similarly, one or more processing elements may be included in short to medium range wireless communication circuitry 429. Thus, cellular communication circuitry 430 may include one or more integrated circuits (Ics) that are configured to perform the functions of cellular communication circuitry 430. In addition, each integrated circuit may include circuitry (e.g., first circuitry, second circuitry, etc.) configured to perform the functions of cellular communication circuitry 430. Similarly, the short to medium range wireless communication circuitry 429 may include one or more Ics that are configured to perform the functions of short to medium range wireless communication circuitry 429. In addition, each integrated circuit may include circuitry (e.g., first circuitry, second circuitry, etc.) configured to perform the functions of short to medium range wireless communication circuitry 429.

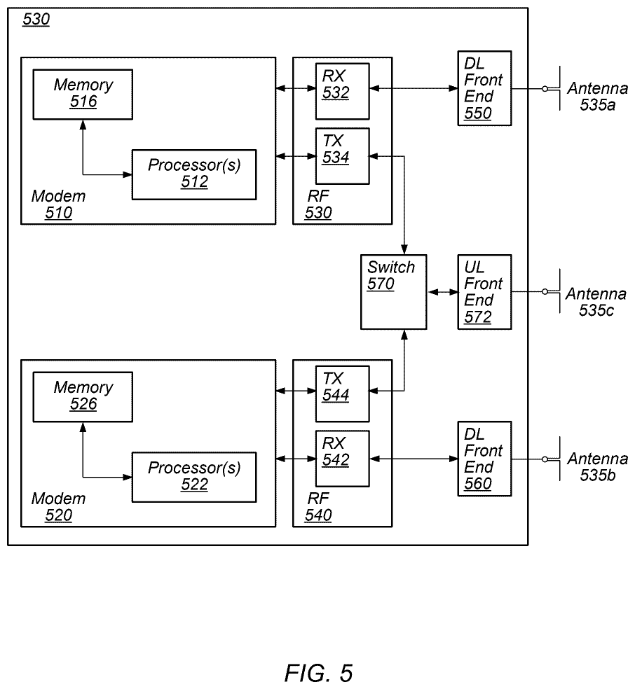

### FIG. 5: Block Diagram of Cellular Communication Circuitry

FIG. 5 illustrates an example simplified block diagram of cellular communication circuitry, according to some embodiments. It is noted that the block diagram of the cellular communication circuitry of FIG. 5 is only one example of a possible cellular communication circuit. According to embodiments, cellular communication circuitry 530, which may be cellular modem circuitry 434, may be included in a communication device, such as communication device 106/107 described above. As noted above, communication device 106/107 may be a user equipment (UE) device, a mobile device or mobile station, a wireless device or wireless station, a desktop computer or computing device, a mobile computing device (e.g., a laptop, notebook, or portable computing device), a tablet, a wearable device, and/or a combination of devices, among other devices.

The cellular communication circuitry 530 may couple (e.g., communicatively; directly or indirectly) to one or more antennas, such as antennas 535a-c (which may be antennas 435a-c of FIG. 4). In some embodiments, cellular communication circuitry 530 may include dedicated receive chains (including and/or coupled to, e.g., communicatively; directly or indirectly. dedicated processors and/or radios) for multiple RATs (e.g., a first receive chain for LTE and a second receive chain for 5G NR). For example, as shown in FIG. 5, cellular communication circuitry 530 may include a modem 510 and a modem 520. Modem 510 may be configured for communications according to a first RAT, e.g., such as LTE or LTE-A, and modem 520 may be configured for communications according to a second RAT, e.g., such as 5G NR.

As shown, modem 510 may include one or more processors 512 and a memory 516 in communication with processors 512. Modem 510 may be in communication with a radio frequency (RF) front end 530. RF front end 530 may include circuitry for transmitting and receiving radio signals. For example, RF front end 530 may include receive circuitry (RX) 532 and transmit circuitry (TX) 534. In some embodiments, receive circuitry 532 may be in communication with downlink (DL) front end 550, which may include circuitry for receiving radio signals via antenna 535a.

Similarly, modem 520 may include one or more processors 522 and a memory 526 in communication with processors 522. Modem 520 may be in communication with an RF front end 540. RF front end 540 may include circuitry for transmitting and receiving radio signals. For example, RF front end 540 may include receive circuitry 542 and transmit circuitry 544. In some embodiments, receive circuitry 542 may be in communication with DL front end 560, which may include circuitry for receiving radio signals via antenna 535b.

In some embodiments, a switch 570 may couple transmit circuitry 534 to uplink (UL) front end 572. In addition, switch 570 may couple transmit circuitry 544 to UL front end 572. UL front end 572 may include circuitry for transmitting radio signals via antenna 535c. Thus, when cellular communication circuitry 530 receives instructions to transmit according to the first RAT (e.g., as supported via modem 510), switch 570 may be switched to a first state that allows modem 510 to transmit signals according to the first RAT (e.g., via a transmit chain that includes transmit circuitry 534 and UL front end 572). Similarly, when cellular communication circuitry 530 receives instructions to transmit according to the second RAT (e.g., as supported via modem 520), switch 570 may be switched to a second state that allows modem 520 to transmit signals according to the second RAT (e.g., via a transmit chain that includes transmit circuitry 544 and UL front end 572).

In some embodiments, the cellular communication circuitry 530 may be configured to perform methods for positioning procedures for reduced capacity devices, e.g., in 5G NR systems and beyond, as further described herein.

As described herein, the modem 510 may include hardware and software components for implementing the above features or for time division multiplexing UL data for NSA NR operations, as well as the various other techniques described herein. The processors 512 may be configured to implement part or all of the features described herein, e.g., by executing program instructions stored on a memory medium (e.g., a non-transitory computer-readable memory medium). Alternatively (or in addition), processor 512 may be configured as a programmable hardware element, such as an FPGA (Field Programmable Gate Array), or as an ASIC (Application Specific Integrated Circuit). Alternatively (or in addition) the processor 512, in conjunction with one or more of the other components 530, 532, 534, 550, 570, 572, 535a-c may be configured to implement part or all of the features described herein.

In addition, as described herein, processors 512 may include one or more processing elements. Thus, processors 512 may include one or more integrated circuits (Ics) that are configured to perform the functions of processors 512. In addition, each integrated circuit may include circuitry (e.g., first circuitry, second circuitry, etc.) configured to perform the functions of processors 512.

As described herein, the modem 520 may include hardware and software components for implementing the above features for positioning procedures for reduced capacity devices, e.g., in 5G NR systems and beyond, as well as the various other techniques described herein. The processors 522 may be configured to implement part or all of the features described herein, e.g., by executing program instructions stored on a memory medium (e.g., a non-transitory computer-readable memory medium). Alternatively (or in addition), processor 522 may be configured as a programmable hardware element, such as an FPGA (Field Programmable Gate Array), or as an ASIC (Application Specific Integrated Circuit). Alternatively (or in addition) the processor 522, in conjunction with one or more of the other components 540, 542, 544, 550, 570, 572, 535a-c may be configured to implement part or all of the features described herein.

In addition, as described herein, processors 522 may include one or more processing elements. Thus, processors 522 may include one or more integrated circuits (Ics) that are configured to perform the functions of processors 522. In addition, each integrated circuit may include circuitry (e.g., first circuitry, second circuitry, etc.) configured to perform the functions of processors 522.

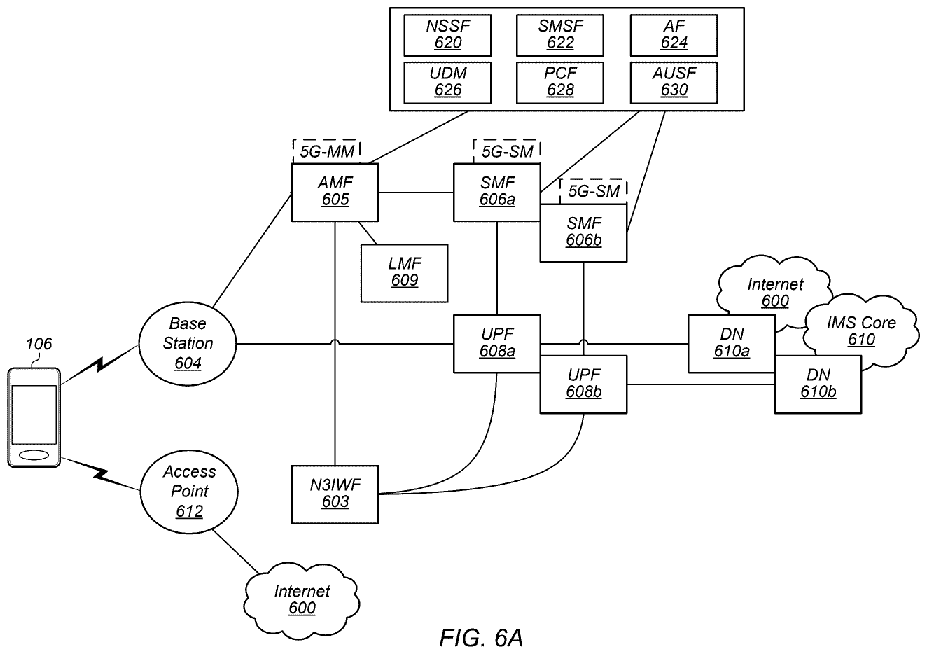

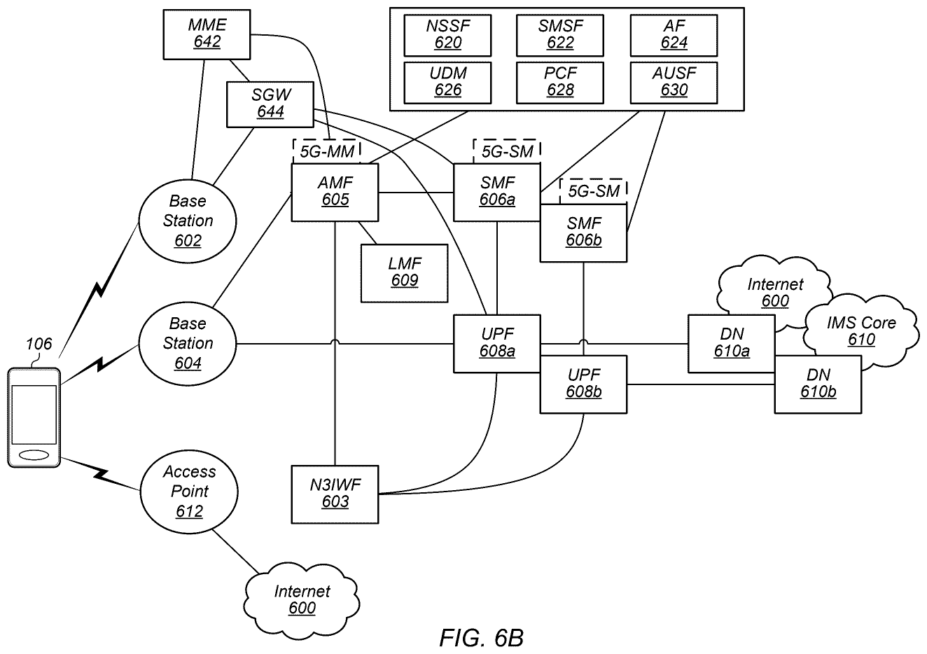

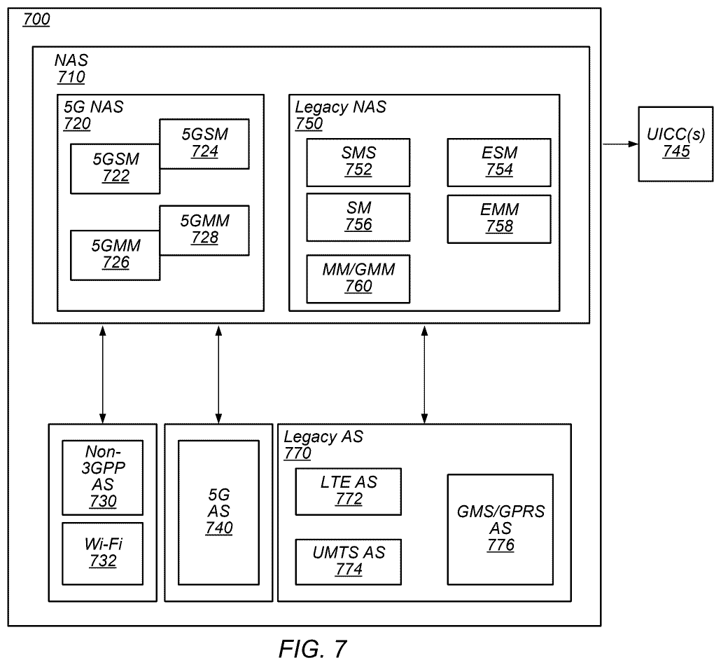

FIGS. 6A, 6B and 7: 5G Core Network Architecture—Interworking with Wi-Fi

In some embodiments, the 5G core network (CN) may be accessed via (or through) a cellular connection/interface (e.g., via a 3GPP communication architecture/protocol) and a non-cellular connection/interface (e.g., a non-3GPP access architecture/protocol such as Wi-Fi connection). FIG. 6A illustrates an example of a 5G network architecture that incorporates both 3GPP (e.g., cellular) and non-3GPP (e.g., non-cellular) access to the 5G CN, according to some embodiments. As shown, a user equipment device (e.g., such as UE 106) may access the 5G CN through both a radio access network (RAN, e.g., such as gNB 604, which may be a base station 102) and an access point, such as AP 612. The AP 612 may include a connection to the Internet 600 as well as a connection to a non-3GPP inter-working function (N3IWF) 603 network entity. The N3IWF may include a connection to a core access and mobility management function (AMF) 605 of the 5G CN. The AMF 605 may include an instance of a 5G mobility management (5G MM) function associated with the UE 106/107. In addition, the RAN (e.g., gNB 604) may also have a connection to the AMF 605. Thus, the 5G CN may support unified authentication over both connections as well as allow simultaneous registration for UE 106/107 access via both gNB 604 and AP 612. As shown, the AMF 605 may be in communication with a location management function (LMF) 609 via a networking interface, such as an NLs interface. The LMF 609 may receive measurements and assistance information from the RAN (e.g., gNB 604) and the UE (e.g., UE 106) via the AMF 605. The LMF 609 may be a server (e.g., server 104) and/or a functional entity executing on a server. Further, based on the measurements and/or assistance information received from the RAN and the UE, the LMF may determine a location of the UE. In addition, the AMF 605 may include one or more functional entities associated with the 5G CN (e.g., network slice selection function (NSSF) 620, short message service function (SMSF) 622, application function (AF) 624, unified data management (UDM) 626, policy control function (PCF) 628, and/or authentication server function (AUSF) 630). Note that these functional entities may also be supported by a session management function (SMF) 606a and an SMF 606b of the 5G CN. The AMF 605 may be connected to (or in communication with) the SMF 606a. Further, the gNB 604 may in communication with (or connected to) a user plane function (UPF) 608a that may also be communication with the SMF 606a. Similarly, the N3IWF 603 may be communicating with a UPF 608b that may also be communicating with the SMF 606b. Both UPFs may be communicating with the data network (e.g., DN 610a and 610b) and/or the Internet 600 and Internet Protocol (IP) Multimedia Subsystem/IP Multimedia Core Network Subsystem (IMS) core network 610.

FIG. 6B illustrates an example of a 5G network architecture that incorporates both dual 3GPP (e.g., LTE and 5G NR) access and non-3GPP access to the 5G CN, according to some embodiments. As shown, a user equipment device (e.g., such as UE 106) may access the 5G CN through both a radio access network (RAN, e.g., such as gNB 604 or eNB 602, which may be a base station 102) and an access point, such as AP 612. The AP 612 may include a connection to the Internet 600 as well as a connection to the N3IWF 603 network entity. The N3IWF may include a connection to the AMF 605 of the 5G CN. The AMF 605 may include an instance of the 5G MM function associated with the UE 106/107. In addition, the RAN (e.g., gNB 604) may also have a connection to the AMF 605. Thus, the 5G CN may support unified authentication over both connections as well as allow simultaneous registration for UE 106/107 access via both gNB 604 and AP 612. In addition, the 5G CN may support dual-registration of the UE on both a legacy network (e.g., LTE via eNB 602) and a 5G network (e.g., via gNB 604). As shown, the eNB 602 may have connections to a mobility management entity (MME) 642 and a serving gateway (SGW) 644. The MME 642 may have connections to both the SGW 644 and the AMF 605. In addition, the SGW 644 may have connections to both the SMF 606a and the UPF 608a. As shown, the AMF 605 may be in communication with an LMF 609 via a networking interface, such as an NLs interface, e.g., as described above, and may include one or more functional entities associated with the 5G CN (e.g., NSSF 620, SMSF 622, AF 624, UDM 626, PCF 628, and/or AUSF 630). Note that UDM 626 may also include a home subscriber server (HSS) function and the PCF may also include a policy and charging rules function (PCRF). Note further that these functional entities may also be supported by the SMF606a and the SMF 606b of the 5G CN. The AMF 606 may be connected to (or in communication with) the SMF 606a. Further, the gNB 604 may in communication with (or connected to) the UPF 608a that may also be communication with the SMF 606a. Similarly, the N3IWF 603 may be communicating with a UPF 608b that may also be communicating with the SMF 606b. Both UPFs may be communicating with the data network (e.g., DN 610a and 610b) and/or the Internet 600 and IMS core network 610.

Note that in various embodiments, one or more of the above-described network entities may be configured to perform methods for positioning procedures for reduced capacity devices, e.g., in 5G NR systems and beyond, e.g., as further described herein.

FIG. 7 illustrates an example of a baseband processor architecture for a UE (e.g., such as UE 106), according to some embodiments. The baseband processor architecture 700 described in FIG. 7 may be implemented on one or more radios (e.g., radios 429 and/or 430 described above) or modems (e.g., modems 510 and/or 520) as described above. As shown, the non-access stratum (NAS) 710 may include a 5G NAS 720 and a legacy NAS 750. The legacy NAS 750 may include a communication connection with a legacy access stratum (AS) 770. The 5G NAS 720 may include communication connections with both a 5G AS 740 and a non-3GPP AS 730 and Wi-Fi AS 732. The 5G NAS 720 may include functional entities associated with both access stratums. Thus, the 5G NAS 720 may include multiple 5G MM entities 726 and 728 and 5G session management (SM) entities 722 and 724. The legacy NAS 750 may include functional entities such as short message service (SMS) entity 752, evolved packet system (EPS) session management (ESM) entity 754, session management (SM) entity 756, EPS mobility management (EMM) entity 758, and mobility management (MM)/GPRS mobility management (GMM) entity 760. In addition, the legacy AS 770 may include functional entities such as LTE AS 772, UMTS AS 774, and/or GSM/GPRS AS 776.

Thus, the baseband processor architecture 700 allows for a common 5G-NAS for both 5G cellular and non-cellular (e.g., non-3GPP access). Note that as shown, the 5G MM may maintain individual connection management and registration management state machines for each connection. Additionally, a device (e.g., UE 106) may register to a single PLMN (e.g., 5G CN) using 5G cellular access as well as non-cellular access. Further, it may be possible for the device to be in a connected state in one access and an idle state in another access and vice versa. Finally, there may be common 5G-MM procedures (e.g., registration, de-registration, identification, authentication, as so forth) for both accesses.

Note that in various embodiments, one or more of the above-described functional entities of the 5G NAS and/or 5G AS may be configured to perform methods for positioning procedures for reduced capacity devices, e.g., in 5G NR systems and beyond, e.g., as further described herein.

### Positioning Procedures for Reduced Capacity Devices

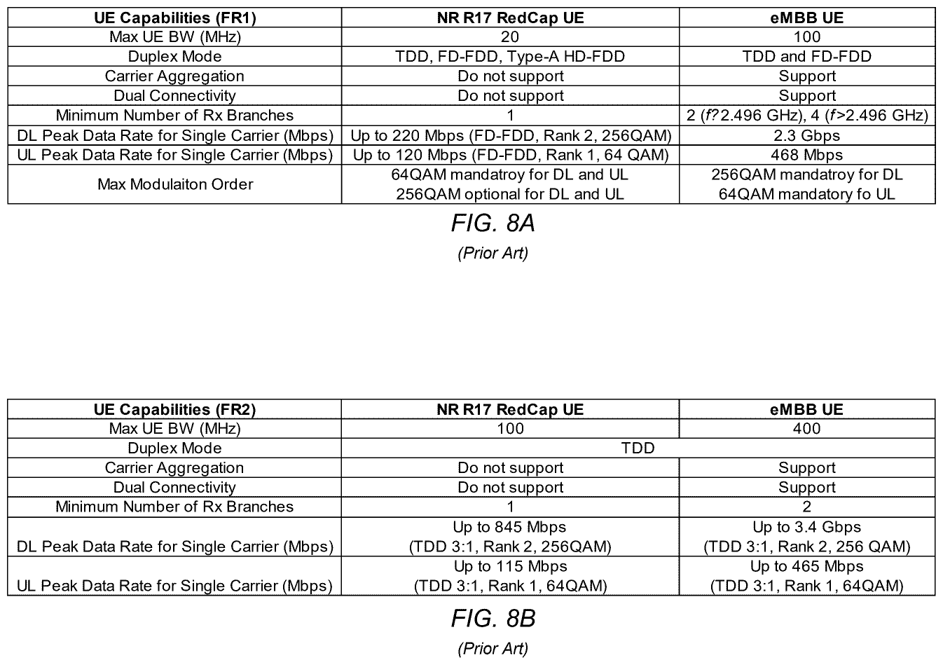

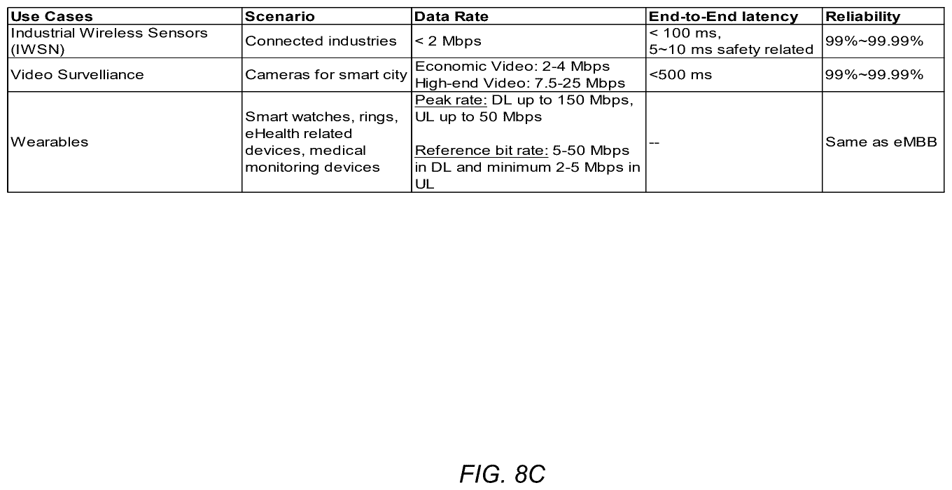

3GPP Release 17 introduced reduced capacity (RedCap) devices (e.g., UEs) with reduced capabilities as compared to existing enhanced mobile broadband (cMBB) devices in both Frequency Range 1 (FR1) (e.g., frequencies below 7.125 GHZ and Frequency Range 2 (FR2) (e.g., frequencies above 24.25 GHZ), e.g., as illustrated by FIGS. 8A and 8B. For example, as shown by FIG. 8A, in FR1, a RedCap UE, as compared to existing cMBB devices, may have a reduced maximum UE bandwidth, not support all duplex modes, not support carrier aggregation or dual connectivity, have a lower minimum number of receive branches, have lower downlink and uplink peak data rates for single carrier, and a different maximum modulation order. As another example, as shown by FIG. 8B, in FR2, a RedCap UE, as compared to existing eMBB devices, may have a reduced maximum UE bandwidth, may not support carrier aggregation or dual connectivity, a reduced maximum number of receive branches, and have lower downlink and uplink peak data rates for single carrier. In addition, as illustrated by FIG. 8C, requirements for various types of RedCap devices (e.g., wearables, industrial wireless sensors, and video surveillance devices) have been specified.

In addition, positioning capabilities for RedCap devices may be limited. For example, RedCap devices may have limited positioning reference signal (PRS) processing bandwidth, limited PRS processing capabilities, limited PRS resource configuration capabilities, and/or limited simultaneous positioning method capabilities, e.g., as compared to existing cMBB devices.

Embodiments described herein provided systems, methods, and mechanisms for positioning procedures for reduced capacity devices, including systems, methods and mechanisms for group based reduced capacity (RedCap) positioning, for positioning configuration and RedCap discontinuous reception cycle (DRX), for positioning and RedCap synchronization signal block (SSB), and for RedCap positioning and half duplex frequency division duplexing (HD-FDD). Thus, for example, the embodiments described herein address problems associated with group-based positioning for RedCap devices in close proximity, how a PRS transmission/reception and/or a sounding reference signal (SRS) transmission/reception interacts with a RedCap device's extended DRX procedure as well as how positioning configurations interact with RedCap SSB and HD-FDD transmission.

In some instances, a positioning configuration, e.g., a PRS configuration, may be configured by a base station, such as base station 102, in an initial bandwidth part (BWP). For example, a positioning operation may be configured in a separate initial BWP, in a common initial BWP, and/or in both a separate BWP and a common initial BWP.

In some instances, e.g., when a positioning method uses and/or is augmented with an SSB, an SSB location may need to be determined. For example, when both a legacy SSB and an additional SSB are present, then measurement feedback to an LMF may be defined for both SSB types. In addition, a UE may indicate a capability and presence of an additional SSB for positioning to the LMF. Further, for feedback for SSB based positioning (e.g., SSB-RSRP), the UE may provide separate feedback, e.g., location and measurement of the additional SSB and/or the UE may provide feedback of one effective SSB measurement to the LMF.

In some instances, e.g., in cases of collision between downlink PRS within a PRS processing window and other uplink transmission, a UE may measure the downlink PRS (e.g., a PRS processing window has priority to measure the downlink PRS over all uplink signals). Additionally, the PRS processing window may be configured to have lower priority than uplink signals in specific instances, e.g., such as for low mobility UEs. In such instances, a low mobility UE may ignore the PRS from a base station and send uplink signals to a serving cell during a measurement gap.

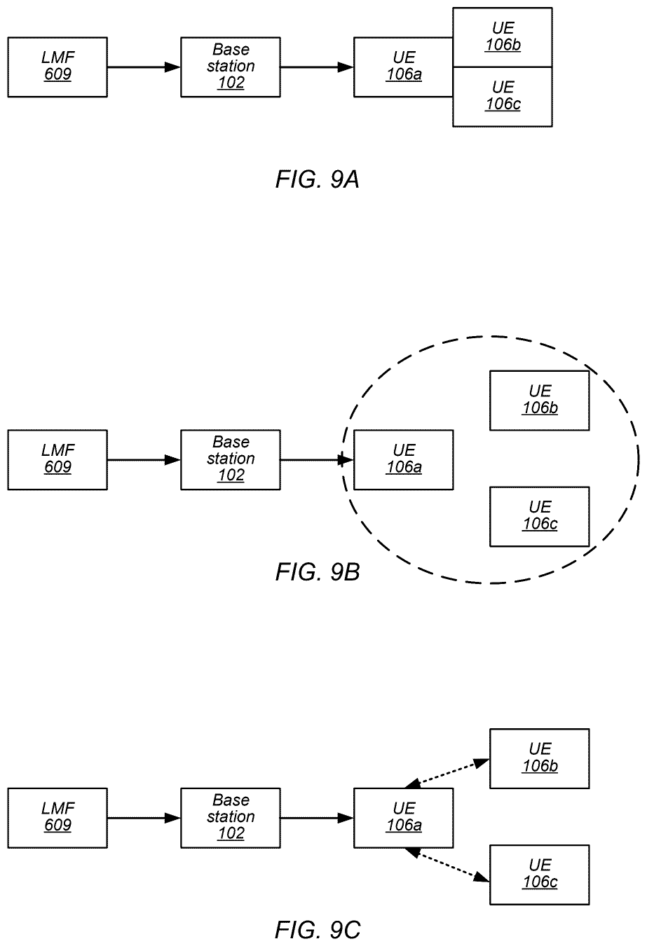

In some instances, for a group of UEs (e.g., a group of RedCap UEs), rather than each UE estimating its position independently, the group of UEs may cooperate to estimate their positions. For example, as illustrated by FIG. 9A, the UEs may be co-located at a location and an estimation of one of the UEs location (e.g., UE 106a) may serve as an estimate for location of all UEs (e.g., UEs 106b-c) in the group, e.g., via a positioning procedure with a base station, such as base 102, that is supported by a location management function (LMF), such as LMF 609. As another example, as illustrated by FIG. 9B, for a group of UEs. e.g., not co-located at a location, positioning requirements may be such that a positioning error resulting from using one UE (e.g., UE 106a) within a certain distance (or bound) of other UEs (e.g., UEs 106b-c) in the group may be acceptable for estimating a location of all UEs in the group, e.g., via a positioning procedure with a base station, such as base 102, that is supported by a location management function (LMF), such as LMF 609. As a further example, as illustrated by FIG. 9C, a delegate UE (e.g., UE 106a) may be determined/nominated to estimate its location (e.g., with a base station, such as base station 102 via a Uu link), e.g., via a positioning procedure with a base station, such as base 102, that is supported by a location management function (LMF), such as LMF 609, and then may perform a local positioning estimate (e.g., an intra-group positioning estimate) with the rest of the UEs (e.g., UEs 106b-c) in the group of UEs. Note that the intra-group positioning estimate may occur at larger time intervals than the estimate with the Uu link. Note further that the intra-group positioning estimate may be periodic, could be UE initiated, and may be based on sidelink positioning methods.

For example, for a group-based RedCap positioning procedure, one or more UEs (e.g., one or more RedCap UEs, such as UE 106 and/or UE 107) may autonomously form a group. The formation may be accomplished via sidelink communication, ProSe communication, and/or some other form of direct communication between UEs. The UEs may identify (and/or elect) a positioning delegate UE (e.g., such as UE 106a of FIG. 9A) and send group information to a location management function (LMF), such as LMF 609. The LMF may then initiate a positioning procedure with the positioning delegate UE using a base station, such as base station 102. The LMF may estimate a position of the positioning delegate UE (and/or the group) if the positioning procedure is LMF based. Alternatively, the positioning delegate UE may estimate its position (and/or the position of the group) if the positioning procedure is UE based. The positioning information (e.g., the positioning estimation) may then be sent to the group via a broadcast to the group from the LMF or the positioning delegate UE and/or via a unicast message to each UE of the group individually from the LMF or the positioning delegate UE.

As another example, for a group-based RedCap positioning procedure, a location management function (LMF), such as LMF 609, or some other entity external to a group of UEs, may determine UEs for the group of UEs. An LMF and/or a base station, such as base station 102, may identify the group of UEs (e.g., after each UE has performed an individual positioning procedure with the base station and LMF). Then the LMF/base station may query the group of UEs to determine whether the UEs can delegate (and/or elect) a UE from within the group of UEs for positioning. The LMF/base station may then form the group with the delegated/elected UE from within the group of UEs designated as a positioning delegate UE. The LMF may then initiate a positioning procedure with the positioning delegate UE (e.g., such as UE 106a of FIG. 9B). The LMF may estimate a position of the positioning delegate UE (and/or the group) if the positioning procedure is LMF based. Alternatively, the positioning delegate UE may estimate its position (and/or the position of the group) if the positioning procedure is UE based. The positioning information (e.g., the positioning estimation) may then be sent to the group via broadcast to the group from the LMF or the positioning delegate UE and/or via a unicast message to each UE of the group individually from the LMF or the positioning delegate UE.

As a further example, for a group-based RedCap positioning procedure, an LMF and/or base station may configure multiple positioning reference signals (PRSs) and/or a sounding reference signals (SRSs) in separate UEs to overlap in frequency. Then, the LMF/base station may collate measurements from the group of UEs to estimate a position of the group of UEs over a larger effective bandwidth. For example, assume a first UE (UE1) is configured to receive a PRS over physical resource blocks (PRBs) 1, 2 and 3 and a second UE (UE2) configured to receive a PRS over PRBs 3, 4 and 5. The LMF/base station may estimate a position based on combining measurements from the UEs over PRBs 1, 2, 3, 4 and 5.

Note that for Round Trip Time (RTT) based positioning, accuracy for a two-way RTT procedure may be a function of an interval between two transmissions. In group based positioning, for a group of UEs, the group of UEs may use an RTT for a UE with an earliest scheduled return transmission to improve positioning accuracy of the entire group.

As yet another example, for a group-based RedCap positioning procedure, a location management function (LMF), such as LMF 609, or some other entity external to a group of UEs, may determine UEs for the group of UEs. An LMF and/or a base station, such as base station 102, may identify the group of UEs (e.g., after each UE has performed an individual positioning procedure with the base station and LMF). Then the LMF/base station may query the group of UEs to determine whether the UEs can delegate (and/or elect) a UE (e.g., such as UE 106a of FIG. 9C) from within the group of UEs for positioning. The LMF/base station may then form the group with the delegated/elected UE from within the group of UEs designated as a positioning delegate UE. Alternatively, the one or more UEs may autonomously form a group. The formation may be accomplished via sidelink communication, ProSc communication, and/or some other form of direct communication between UEs. The UEs may identify (and/or elect) a positioning delegate UE (e.g., such as UE 106a of FIG. 9C) and send group information to a location management function (LMF), such as LMF 609. The LMF may then initiate a positioning procedure with the positioning delegate UE using a base station, such as base station 102. The LMF may estimate a position of the positioning delegate UE (and/or the group) if the positioning procedure is LMF based. Alternatively, the positioning delegate UE may estimate its position (and/or the position of the group) if the positioning procedure is UE based. The delegate UE (e.g., UE 106a of FIG. 9C) may then perform a local positioning estimate (e.g., an intra-group estimate) with each of the other UEs (e.g., UEs 106b-c) to estimate a position of the other UEs relative to the delegate UE. In some instances, the intra-group positioning estimate may occur at larger time intervals than the estimate with the Uu link. The intra-group positioning estimate may be periodic, could be UE initiated, and may be based on sidelink positioning methods.

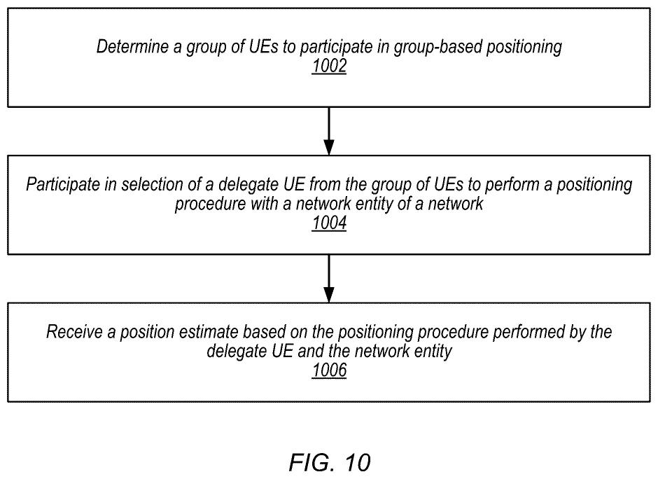

FIG. 10 illustrates a block diagram of an example of a method for group-based positioning, according to some embodiments. The method shown in FIG. 10 may be used in conjunction with any of the systems, methods, or devices shown in the Figures, among other devices. In various embodiments, some of the method elements shown may be performed concurrently, in a different order than shown, or may be omitted. Additional method elements may also be performed as desired. As shown, this method may operate as follows.

At 1002, a UE, such as UE 106 and/or UE 107 may determine a group of UEs to participate in group-based positioning. In at least some instances, the UE may be a reduced capacity (RedCap) UE.

At 1004, the UE may participate in selection of a delegate UE from the group of UEs. The delegate UE may perform a positioning procedure with the network entity of the network.

At 1006, the UE may receive a position estimate based on the positioning procedure performed by the delegate UE and the network entity.

In some instances, to determine the group of UEs, the UE may receive, from a location management function (LMF), an indication of a proposed delegate UE to perform the positioning procedure on behalf of the group of UEs, including the UE. Additionally, the UE may reply, to the LMF, acceptance of the proposed delegate UE to perform the positioning procedure on behalf of the group UEs, including the UE.

In some instances, to determine the group of UEs, the UE may discover neighboring UEs via peer-to-peer communication and indicate, to the neighboring UEs, a delegate capability and a required positioning accuracy. Additionally, the UE may receive, from the neighboring UEs, delegate capabilities and required positioning accuracies and form the group of UEs.

In some instances, participation in the selection of the delegate UE may include the UE sending, to the LMF, a delegate capability and an accuracy capability and receiving, from the LFM, an indication of a selected delegate UE. The selection of the delegate UE may be based on delegate capabilities and accuracy capabilities of the group of UEs. In some instances, the delegate capability may indicate whether or not the UE can serve as a delegate UE. In some instances, the accuracy capability may provide an indication of whether the UE is a reduced capacity UE. In some instances, the UE may receive, from the LMF, a position of the UE relative to the delegate UE. In some instances, the UE may receive, from the LMF, an instruction to estimate intra-group position relative to the delegate UE.

In some instances, the indication of the selected delegate may indicate that the UE is the selected delegate. In such instances, the UE may perform a positioning procedure with the LMF. In addition, the UE may perform an intra-group positioning procedure with each UE of the group of UEs.

In some instances, participating in selection of the delegate UE may include the UE exchanging, with UEs in the group of UEs, a delegate capability and an accuracy capability and selecting, via communications with the UEs in the group of UEs, a delegate UE. In some instances, selection of the delegate UE may be based, at least in part, on delegate capabilities and accuracy capabilities of the UEs of the group of UEs. In some instances, the delegate UE may be randomly selected from the group of UEs.

In some instances, to receive the position estimate based on the positioning procedure performed by the delegate UE and the network entity, the UE may receive, from the LMF, a broadcast of the position estimate. In some instances, to receive the position estimate based on the positioning procedure performed by the delegate UE and the network entity, the UE may receive, from the LMF, a unicast message that includes the position estimate and a delta distance to other UEs in the group of UEs. In some instances, to receive the position estimate based on the positioning procedure performed by the delegate UE and the network entity, the UE may receive, from the delegate UE, the position estimate. In some instances, to receive the position estimate based on the positioning procedure performed by the delegate UE and the network entity, the UE may receive, from the LMF, positioning estimates and send, to UEs of the group of UEs, the positioning estimates (e.g., when the UE is the delegate UE).

In some instances, a PRS measurement requirement and/or an SRS transmission requirement may be defined independent of a DRX configuration. That is, when a UE is configured with DRX, the UE may also wake up to measure PRS and/or transmit SRS during the DRX inactive time. In some instances, an LMF may indicate a switch for DRX impact, e.g., when the switch is turned on, the UE may only measure PRS and/or transmit SRS during a DRX active time, otherwise, the UE measures PRS and/or transmits SRS regardless of DRX configuration.

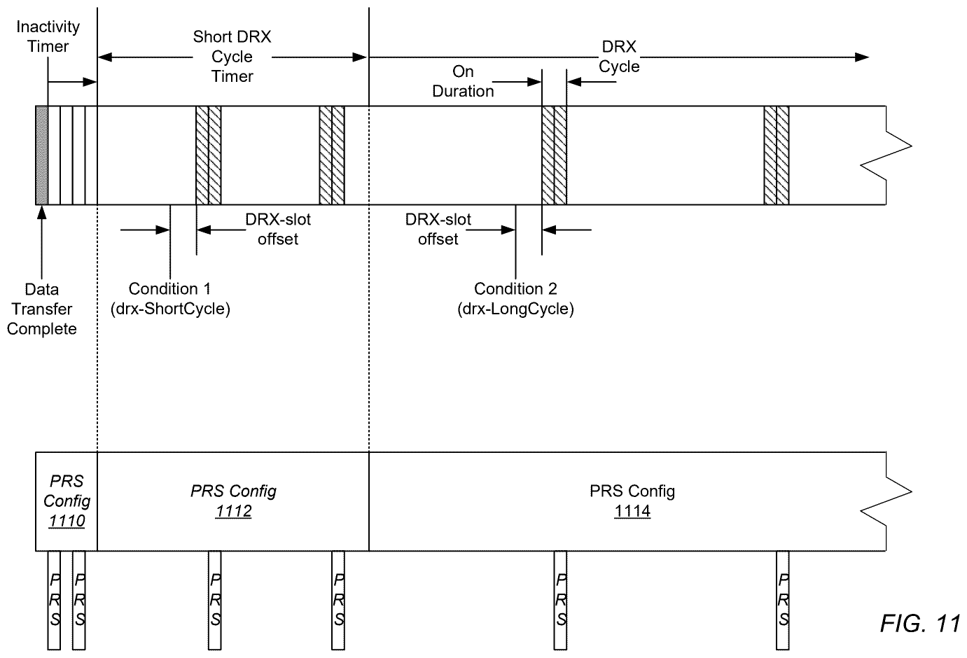

In some instance, e.g., when a UE is in an RRC connected mode, the UE may have long and short DRX cycles with different DRX on durations. Thus, a PRS/SRS configuration (e.g., periodicity) may be associated with (tied to) a DRX cycle a UE is in to ensure that the PRS/SRS used for positioning matches the DRX ON duration. In other words, a periodicity of the PRS/SRS is modified (and/or adjusted) to match a periodicity of DRX ON time (and on duration) such that at least one positioning operation occurs within the DRX ON duration. For example, FIG. 11 illustrates an example of multiple PRS/SRS configurations associated with a UE's DRX, according to some embodiments. As shown, a first PRS configuration 1110, e.g., with a first PRS periodicity may be associated with non-DRX operation of a UE, such as UE 106/107. Upon completion of a data transfer, the UE may start an inactivity timer prior to entering a DRX cycle. As shown, upon expiration of the inactivity timer, e.g., without any data transfer, the UE may enter a short DRX cycle. Additionally, the UE/network may switch to a PRS configuration 1112 associated with the short DRX cycle. Thus, as shown, PRSs during the short DRX cycle may align with DRX on durations. Upon expiration of a short DRX cycle timer, the UE may enter a long DRX cycle in which a time between DRX on cycles is longer than a time between DRX on cycles in a short DRX cycle. Additionally, the UE/network may switch to a PRS configuration 1114 associated with the long DRX cycle. Thus, as shown, PRSs during the long DRX cycle may align with DRX on durations. Note that the configuration may be adjusted to ensure that multiple repetitions of the PRS/SRS occur within DRX ON duration for accuracy. Note further that for typical cells, a base station may have multiple configurations that are meant for multiple UEs. In such instances, a UE may choose a configuration that is needed. Additionally, for small cells, e.g., with a small number of UEs, the base station may activate/deactivate configurations needed based on the UEs to be transmitted to for power savings. In some instances, a wakeup signal (WUS), which is used in RRC connected mode to identify if the UE should switch to DRX ON, may be used as an indicator to trigger which PRS configuration is to be used. In some instances, a PRS may be sent based on timing of the WUS.

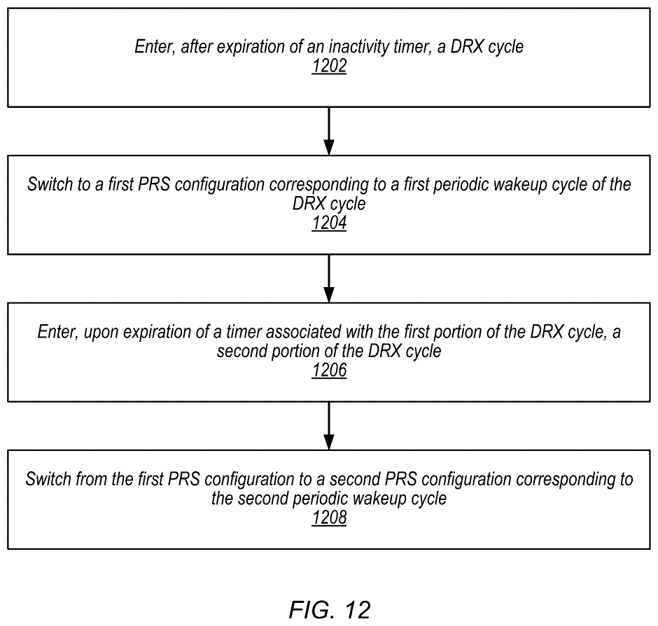

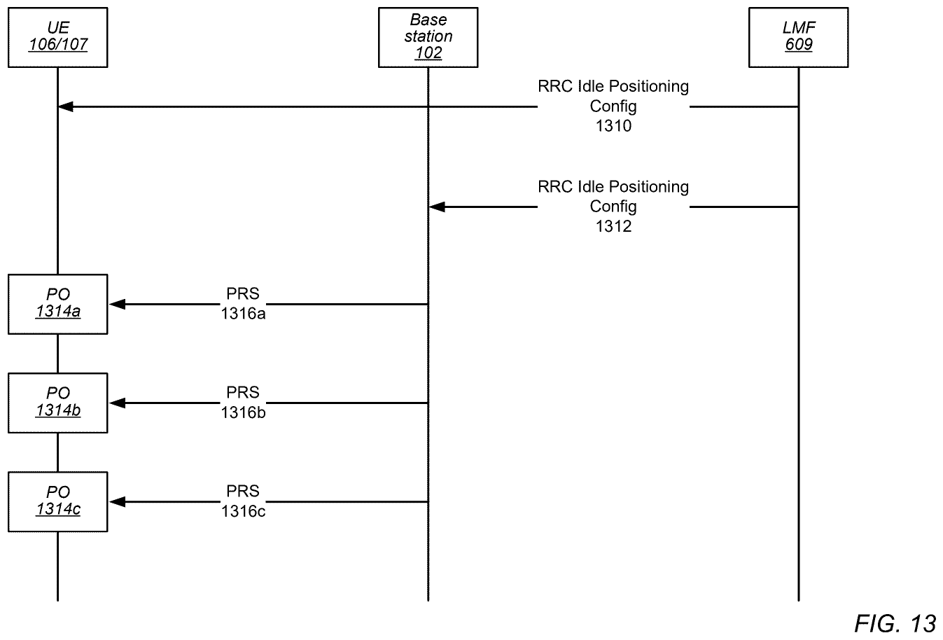

FIG. 12 illustrates a block diagram of an example of a method for reception of positioning reference signals (PRSs) during a discontinuous reception cycle (DRX), according to some embodiments. The method shown in FIG. 12 may be used in conjunction with any of the systems, methods, or devices shown in the Figures, among other devices. In various embodiments, some of the method elements shown may be performed concurrently, in a different order than shown, or may be omitted. Additional method elements may also be performed as desired. As shown, this method may operate as follows.

At 1202, a UE, such as UE 106 and/or UE 107, may enter, after expiration of an inactivity timer, a DRX cycle. In some instances, the UE may be operating in a radio resource control (RRC) connected mode. In at least some instances, the UE may be a reduced capacity (RedCap) UE.

At 1204, the UE may switch to a first PRS configuration. The first PRS configuration may correspond to a first periodic wakeup cycle of the DRX cycle. In some instances, the switch to the first PRS configuration may include and/or be based on the UE receiving, from a base station, such as base station 102, a wakeup signal (WUS). The WUS may indicate to the UE to switch to the first PRS configuration. In some instances, the UE may receive, from the base station (e.g., while in the first PRS configuration), a PRS, where a timing of the PRS is based on the WUS. In some instances, the timing of the PRS may be indicated by the first PRS configuration.

At 1206, the UE may enter, upon expiration of a timer associated with a first portion of the DRX cycle, a second portion of the DRX cycle. In some instances, the first portion of the DRX cycle may correspond to the first periodic wakeup cycle. In some instances, the second portion of the DRX cycle may correspond to the second periodic wakeup cycle. In some instances, a first time duration between on durations corresponding to the first periodic wakeup cycle may be less than a second time duration between on durations corresponding to the second periodic wakeup cycle.

At 1208, the UE may switch from the first PRS configuration to a second PRS configuration, e.g., based, at least in part, on the expiration of the timer and/or based, at least in part, on entering the second portion of the DRX cycle. The second PRS configuration may correspond to a second periodic wakeup cycle of the DRX cycle.

In some instance, the UE may receive, during an on duration of the first portion of the DRX cycle, at least one PRS based on the first PRS configuration. In some instances, a periodicity of the at least one PRS may be indicated by the first PRS configuration. In some instances, a periodicity of the at least one PRS may be based on the first periodic wakeup cycle Additionally, the UE may receive, during an on duration of the second portion of the DRX cycle, at least one PRS based on the second PRS configuration. In some instances, a periodicity of the at least one PRS may be indicated by the second PRS configuration. In some instances, a periodicity of the at least one PRS may be is based on the second periodic wakeup cycle.

In some instances, the UE may receive, from a base station, such as a base station 102, a plurality of PRS configurations, including the first PRS configuration and the second PRS configuration. The UE may select, based on the first periodic wakeup cycle, the first PRS configuration. Additionally, the UE may select, based on the second periodic wakeup cycle, the second PRS configuration. In some instances, the UE may receive, from the base station, an indication to de-activate at least one PRS configuration of the plurality of PRS configurations. In some instances, the UE may receive, from the base station, an indication to activate at least one PRS configuration of the plurality of PRS configurations.

In some instances, the first PRS configuration may indicate that the PRS is to be received in a separate initial BWP, in a common initial BWP, and/or in both a separate BWP and a common initial BWP. Further, in such instances, the UE may receive, during an on duration of the first portion of the DRX cycle, at least one PRS based on the first PRS configuration in at least one of a separate initial BWP, in a common initial BWP, and/or in both a separate BWP and a common initial BWP.

In some instances, the UE may provide PRS measurement feedback to a location management function (LMF). In some instances, both a legacy synchronization signal block (SSB) and an additional SSB may be present. The UE may indicate, to the LMF, a capability and/or presence of the additional SSB. The PRS measurement feedback may include an SSB reference signal received power (RSRP) for the additional SSB and/or for the legacy SSB. In some instances, the UE may provide feedback of one effective SSB measurement, e.g., based on some combination of the feedback for the legacy SSB and feedback for the additional SSB.

In some instances, the UE may detect a collision between a PRS and an uplink transmission during a PRS processing window. In such instances, the UE may measure the PRS, e.g., during the PRS processing window. the PRS measurement has priority over all uplink signals. In some instances, the PRS measurement during the PRS processing window may be configured to have a lower priority than uplink signals in specific instances, e.g., such as for low mobility UEs. In such instances, a low mobility UE may ignore the PRS from a base station and send uplink signals to a serving cell during a measurement gap.

In some instances, e.g., when a UE is in an RRC idle mode and/or an RRC inactive mode, positioning measurement may be left to UE implementation, a UE may not be expected to perform positioning measurements in RRC idle/inactive mode, a base station may configure whether or not a UE is to measure a PRS, a UE may wake up during a paging occasion (paging cycles) and a positioning measurement may be performed during an active paging (note that a specific PRS/SRS configuration may be used in this mode), and/or depending on positioning requirements, a UE may move to an RRC connected mode at some interval/periodicity to enable positioning measurement (note that a specific PRS/SRS configuration used in this mode). In some instances, positioning measurement feedback, which is typically via LPP (which is a higher layer protocol), may only be allowed in connected mode (e.g., measurement feedback may be skipped in in RRC inactive/idle mode) or may be allowed at specific intervals in RRC inactive/idle mode. In some instances, a UE may, depending on positioning requirements, move to an RRC connected mode at a particular interval or periodicity to enable positioning measurement feedback.

For example, FIG. 13 illustrates an example of signaling for reception of positioning reference signals (PRSs), according to some embodiments. The signaling shown in FIG. 13 may be used in conjunction with any of the systems, methods, or devices shown in the Figures, among other devices. In various embodiments, some of the signaling elements shown may be performed concurrently, in a different order than shown, or may be omitted. Additional signaling elements may also be performed as desired. As shown, the signaling may operate as follows.

As shown, an LMF, such as LMF 609, may transmit an RRC idle mode positioning configuration 1310 to a UE, such as a UE 106 and/or a UE 107. The RRC idle mode positioning configuration 1310 may configure the UE to receive PRSs during paging occasions. In some instances, the RRC idle mode positioning configuration 1310 may include and/or specify a schedule and/or periodicity of paging occasions, such as paging occasions 1314a-c. Additionally, the LMF may transmit an RRC idle mode positioning configuration 1312 to a base station serving the UE, such as a base station 102. The RRC idle mode positioning configuration 1312 may configure the base station to transmit PRSs during paging occasions. In some instances, the RRC idle mode positioning configuration 1312 may include and/or specify a schedule and/or periodicity of paging occasions, such as paging occasions 1314a-c. Further, as shown, the base station may transmit, and the UE may receive, PRSs 1316a-c during paging occasions 1314a-c, e.g., based on the RRC idle mode positioning configurations 1310 and 1312.

The RRC idle mode positioning configuration 1310 may configure the UE to receive PRSs during paging occasions. In some instances, the RRC idle mode positioning configuration 1310 may include and/or specify a schedule and/or periodicity of paging occasions, such as paging occasions 1314a-c.

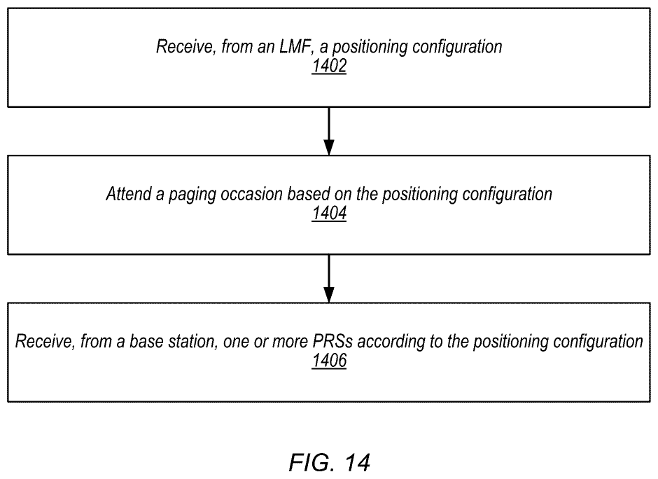

FIG. 14 illustrates a block diagram of an example of a method for reception of a positioning reference signal (PRS) during a paging occasion, according to some embodiments. The method shown in FIG. 14 may be used in conjunction with any of the systems, methods, or devices shown in the Figures, among other devices. In various embodiments, some of the method elements shown may be performed concurrently, in a different order than shown, or may be omitted. Additional method elements may also be performed as desired. As shown, this method may operate as follows.

At 1402, a UE, such as UE 106 and/or UE 107, may receive, from a location management function (LMF), a positioning configuration. In at least some instances, the UE may be a reduced capacity (RedCap) UE. In some instances, the UE may be in a radio resource control (RRC) idle mode and/or in an RRC inactive mode. In some instances, the positioning configuration may be an RRC idle mode positioning configuration. In some instances, the positioning configuration may specify a schedule for the paging occasion and one or more additional paging occasions and/or a periodicity of the paging occasion and the one or more additional paging occasions.

At 1404, the UE may attend a paging occasion, e.g., based on the positioning configuration.

At 1406, the UE may receive, from a base station, such as base station 102, one or more PRSs according to the positioning configuration. In some instances, to receive, from the base station, the one or more PRSs according to the positioning configuration, the UE may receive the one or more PRSs in the paging occasion. In some instances, the positioning configuration may configure the UE to receive the one or more PRSs during the paging occasion.

In some instances, the positioning configuration may include a PRS reporting configuration. The PRS reporting configuration may specify a reporting interval for the UE to report PRS measurements to the LMF and/or a reporting periodicity for the UE to report PRS measurements to the LMF. In some instances, the UE may report, to the LMF, PRS measurements according to the PRS reporting configuration. In some instance, the UE may switch from an RRC idle mode or an RRC inactive mode to an RRC connected mode prior to the reporting. In some instances, the UE may switch from the RRC connected mode to one of the RRC idle mode or the RRC inactive mode after the reporting. In some instances, the UE may perform the reporting while operating in one of an RRC idle mode or an RRC inactive mode. In some instances, the UE may skip one or more PRS reporting opportunities specified by the PRS reporting configuration to remain in one of an RRC idle mode or RRC inactive mode.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Embodiments of the present disclosure may be realized in any of various forms. For example, some embodiments may be realized as a computer-implemented method, a computer-readable memory medium, or a computer system. Other embodiments may be realized using one or more custom-designed hardware devices such as ASICs. Still other embodiments may be realized using one or more programmable hardware elements such as FPGAs.

In some embodiments, a non-transitory computer-readable memory medium may be configured so that it stores program instructions and/or data, where the program instructions, if executed by a computer system, cause the computer system to perform a method, e.g., any of the method embodiments described herein, or, any combination of the method embodiments described herein, or, any subset of any of the method embodiments described herein, or, any combination of such subsets.

In some embodiments, a device (e.g., a UE 106) may be configured to include a processor (or a set of processors) and a memory medium, where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Any of the methods described herein for operating a user equipment (UE) may be the basis of a corresponding method for operating a base station, by interpreting each message/signal X received by the UE in the downlink as message/signal X transmitted by the base station, and each message/signal Y transmitted in the uplink by the UE as a message/signal Y received by the base station.

Although the embodiments above have been described in considerable detail, numerous variations and modifications will become apparent to those skilled in the art once the above disclosure is fully appreciated. It is intended that the following claims be interpreted to embrace all such variations and modifications.

1. A method for group-based positioning, comprising:
a user equipment device (UE),
determining a group of UEs to participate in group-based positioning;
participating in selection of a delegate UE from the group of UEs to perform a positioning procedure with a network entity of a network; and
receiving a position estimate based on the positioning procedure performed by the delegate UE and the network entity.

2. The method of claim 1,
wherein determining the group of UEs comprises the UE:
receiving, from a location management function (LMF) of the network, an indication of a proposed delegate UE to perform the positioning procedure on behalf of the group of UEs, including the UE; and
replying, to the LMF, acceptance of the proposed delegate UE to perform the positioning procedure on behalf of the group UEs, including UE.

3. The method of claim 1,
wherein determining the group of UEs comprises the UE:
discovering neighboring UEs via peer-to-peer communication;
indicating, to the neighboring UEs, a delegate capability and a required positioning accuracy;
receiving, from the neighboring UEs, delegate capabilities and required positioning accuracies; and
forming the group of UEs.

4. The method of claim 1,
wherein participating in the selection of the delegate UE from the group of UEs comprises the UE:
sending, to a location management function (LMF) of the network, a delegate capability and an accuracy capability; and
receiving, from the LMF, an indication of a selected delegate UE, wherein selection of the delegate UE is based on delegate capabilities and accuracy capabilities of the group of UEs.

5. The method of claim 4,
wherein the delegate capability indicates whether or not the UE can serve as a delegate UE.

6. The method of claim 4,
wherein the accuracy capability provides an indication of whether the UE is a reduced capacity UE.

7. The method of claim 4, further comprising:
the UE,
receiving, from the LMF, a position of the UE relative to the delegate UE.

8. The method of claim 4, further comprising:
the UE,
receiving, from the LMF, an instruction to estimate intra-group position relative to the delegate UE.

9. The method of claim 4,
wherein the indication of the selected delegate indicates that the UE is the selected delegate.

10. The method of claim 9, further comprising:
the UE,
performing a positioning procedure with the LMF.

11. The method of claim 10, further comprising:
the UE,
performing an intra-group positioning procedure with each UE of the group of UEs.

12.-21. (canceled)

22. An apparatus, comprising:
a memory; and
processing circuitry in communication with the memory and configured to cause a user equipment device (UE) to:
determine a group of UEs to participate in group-based positioning;
participate in selection of a delegate UE from the group of UEs to perform a positioning procedure with a network entity of a network; and
receive a position estimate based on the positioning procedure performed by the delegate UE and the network entity.

23. The apparatus of claim 22,
wherein, to participate in the selection of the delegate UE from the group of UEs, the processing circuitry is further configured to cause the UE to:
exchange, with UEs in the group of UEs, a delegate capability and an accuracy capability; and
select, via communications with the UEs in the group of UEs, a delegate UE.

24. The apparatus of claim 23,
wherein selection of the delegate UE is based on delegate capabilities and accuracy capabilities of the UEs of the group of UEs.

25. The apparatus of claim 23,
wherein the delegate UE is randomly selected from the group of UEs.

26. The apparatus of claim 22,
wherein, to receive the position estimate based on the positioning procedure performed by the delegate UE and the network entity, the processing circuitry is further configured to cause the UE to:
receive, from a location management function (LMF), a broadcast of the position estimate.

27. The apparatus of claim 22,
wherein, to receive the position estimate based on the positioning procedure performed by the delegate UE and the network entity, the processing circuitry is further configured to cause the UE to:
receive, from a location management function (LMF), a unicast message that includes the position estimate and a delta distance to other UEs in the group of UEs.

28. A non-transitory computer readable memory medium storing instructions executable by a processor of a user equipment device (UE) to:
determine a group of UEs to participate in group-based positioning;
participate in selection of a delegate UE from the group of UEs to perform a positioning procedure with a network entity of a network; and
receive a position estimate based on the positioning procedure performed by the delegate UE and the network entity.

29. The non-transitory computer readable memory medium of claim 28,
wherein, to receive the position estimate based on the positioning procedure performed by the delegate UE and the network entity, the instructions are further executable by the processor of the UE to:
receive, from the delegate UE, the position estimate.

30. The non-transitory computer readable memory medium of claim 28,
wherein, to receive the position estimate based on the positioning procedure performed by the delegate UE and the network entity, the instructions are further executable by the processor of the UE to:
receive, from a location management function (LMF), positioning estimates; and
send, to UEs of the group of UEs, the positioning estimates.
